(19) United States
(12) Patent Application Publication
(10) Pub. No.: US 2006/0027597 A1
(43) Pub. Date: Feb. 9, 2006

(54) Systems, methods and apparatuses for marketing beverages

(76) Inventors: Alvin Frank Chow, Portland, OR (US); Samuel Lewis Orr JR., Hoschton, GA (US); Richard Carroll Staten, Woodstock, GA (US)

Correspondence Address: William R. Silverio;SUTHERLAND ASBILL & BRENNAN LLP, 999 Peachtree Street, NE, Atlanta, GA, 30309-3996, US

(21) Appl. No.: 10/895,211

(22) Filed: Jul. 20, 2004

(51) Int. Cl. B67D 5/56

(52) U.S. Cl. 222/129.1

(57) ABSTRACT

A marketing system including a shelving unit having shelves and an opening. A cooler and beverage dispenser are removably inserted into the opening. The cooler is operable to retain and cool at least one individually-packaged beverage product. The beverage dispenser is operable to dispense a sample of the at least one individually-packaged beverage product to encourage consumers to purchase items on the from the shelves and/or cooler. The marketing system may take the form of an end-of-aisle unit that may be placed in grocery stores and the like.

### FIELD OF THE INVENTION

The present invention relates generally to marketing devices, and more specifically, to systems, methods and apparatuses for displaying and offering samples of drink products.

### BACKGROUND OF THE INVENTION

It is known that a successful marketing effort can result in increased consumer sales for both new and existing products. Nowhere is this more clear than in the sale of beverages, due in large part to the wide variety of drink products and the number of brands available to consumers. A significant challenge in successfully marketing beverages is getting consumers to try the product for the first time. Once this occurs, a superior product helps sell itself. However, a consumer must spend money to purchase the product prior to tasting it for the first time.

Marketing at the point of sale plays an important role in an overall marketing effort, as the point of sale is the location at which a customer makes the final decision to purchase, or not purchase, a drink product. Conventional marketing techniques seek to sell new and existing beverages at the point of sale through brand loyalty and displays that encourage consumers to consider a particular product. This may include presenting products in a particular location or in a particular fashion, or offering the product on sale. Despite these methods, however, the consumer still cannot sample a product at the point of sale prior to deciding whether to purchase the product.

Therefore, what is needed are systems and methods that permit a consumer to sample a beverage prior to purchase.

### BRIEF SUMMARY OF THE INVENTION

According to one embodiment of the present invention, there is disclosed a beverage dispensing apparatus. The apparatus includes a shelving unit having an opening and at least one shelf, and a beverage dispenser operable to dispense at least one beverage, where the beverage dispenser is inserted into the opening in the shelving unit. According to one aspect of the invention, the shelving unit is an end-of-aisle shelving unit having at least three sides approachable by a consumer. According to another aspect of the invention, the opening in the shelving unit is disposed in one of the at least three sides. According to yet another aspect of the present invention, the apparatus also includes at least one cover removably affixed to the shelving unit.

The beverage dispensing apparatus may also include at least one dispensing interface operable to receive input from a consumer to cause the beverage dispenser to dispense the at least one beverage. The at least one dispensing interface may be one or more switches, buttons, levers, and/or motion sensors. According to another aspect of the invention, the beverage dispenser may include a flow regulator operable to control the volume of one or more beverages dispensed by the beverage dispenser. The beverage dispensing apparatus may also include a cup dispenser operable to hold cups. According to one aspect of the invention, the beverage dispenser may be removably inserted into the opening in the shelving unit.

According to another embodiment of the present invention, there is disclosed a marketing system. The marketing system includes a shelving unit having an opening and at least one shelf, a cooler operable to retain at least one individually-packaged beverage product, and a beverage dispenser, where the beverage dispenser is operable to dispense a sample of the at least one individually-packaged beverage product. The sample is separate from the at least one individually-packaged beverage product retained in the cooler. Additionally, the beverage dispenser is removably inserted into the opening in the shelving unit.

According to one aspect of the present invention, the at least one individually-packaged beverage product is a soft drink. According to another aspect of the present invention, the shelving unit is an end-of-aisle shelving unit having at least three sides approachable by a consumer, and the opening is disposed in one of the three sides. According to yet another aspect of the present invention, the marketing system also includes at least one cover removably affixed to the shelving unit.

The marketing system may also include at least one dispensing interface, where the at least one dispensing interface is operable to receive input from a consumer to cause the beverage dispenser to dispense at least one beverage. The at least one dispensing interface may be one or more switches, buttons, levers, and/or motion sensors. The beverage dispenser may also include a flow regulator operable to control the volume of beverage(s) dispensed by the beverage dispenser.

According to yet another aspect of the present invention, the marketing system may also include a card reader that is operable to read information off of a consumer card. The consumer card may be a credit card, smart card, radio frequency tag, frequent shopper card, pre-paid card, receipt, and/or barcode. The marketing system may also include a display device operative to display marketing information to prospective customers. The marketing information may include marketing information corresponding to the at least one individually-packaged beverage product. The marketing system may also include a cup dispenser operable to hold cups.

According to yet another embodiment of the present invention, there is disclosed a marketing system. The system includes a product holder operable to retain at least one individually-packaged beverage product, and a beverage dispenser operable to dispense a sample of the at least one individually-packaged beverage product, where the sample is not provided from the at least one individually-packaged beverage product in the product holder, and wherein the product holder is local to and associated with the beverage dispenser.

According to one aspect of the present invention, the at least one individually-packaged beverage product is a soft drink. According to another aspect of the present invention, the beverage sampling apparatus also includes at least one dispensing interface, where the at least one dispensing interface is operable to receive input from a consumer to cause the beverage dispenser to dispense the sample of the at least one individually-packaged beverage product. The at least one dispensing interface may be selected from the group of interfaces consisting of a switch, a button, a lever, and a motion sensor. The beverage dispenser may also include a flow regulator operable to control the volume of the at least one beverage dispensed by the beverage dispenser.

According to yet another aspect of the present invention, the marketing system may also include a card reader, operable to read information off of a consumer card such as a credit card, smart card, radio frequency tag, frequent shopper card, pre-paid card, and/or barcode. The marketing system may also include at least one display device, where the at least one display device is operable to display marketing information to prospective customers. The marketing information may include information corresponding to the at least one individually-packaged beverage product. The marketing system may also include a cup dispenser operable to hold cups. Furthermore, the product holder may be a cooler that is integrated with the beverage dispenser.

According to another embodiment of the present invention, there is disclosed a marketing method. The method includes the steps of placing a product to be marketed on a shelving unit having an opening and at least one shelf, placing in a cooler at least one individually-packaged beverage product, where the cooler is inserted into the opening, and offering a sample of the at least one individually-packaged beverage product via a beverage dispenser local to the shelving unit and the cooler, where the sample is not provided from the at least one individually-packaged beverage product in the cooler.

According to one aspect of the invention, the step of offering a sample of the at least one individually-packaged beverage product occurs via at least one dispensing interface, where the at least one dispensing interface is operable to receive input from a consumer to cause the beverage dispenser to dispense the at least one beverage. According to another aspect of the present invention, the at least one dispensing interface may include one or more switches, buttons, levers, and/or motion sensors. According to yet another aspect of the present invention, the step of offering a sample of the at least one individually-packaged beverage product includes offering a controlled volume of the sample, where the controlled volume is determined by a flow regulator.

According to another aspect of the invention, the method also includes the step of receiving an input from a consumer prior to offering a sample of the at least one individually-packaged beverage product. Marketing information may also be displayed to prospective consumers via a display device. The marketing information may include information corresponding to the at least one individually-packaged beverage product.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1A shows a perspective view of a beverage marketing system, according to one embodiment of the present invention.

FIG. 1B shows a perspective view of a beverage marketing system, according to another embodiment of the present invention.

FIG. 2 shows a component view of the beverage marketing system shown in FIG. 1A, according to one aspect of the present invention.

FIG. 3 is a block diagram flow chart illustrating a marketing method using a beverage marketing system, according to one embodiment of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

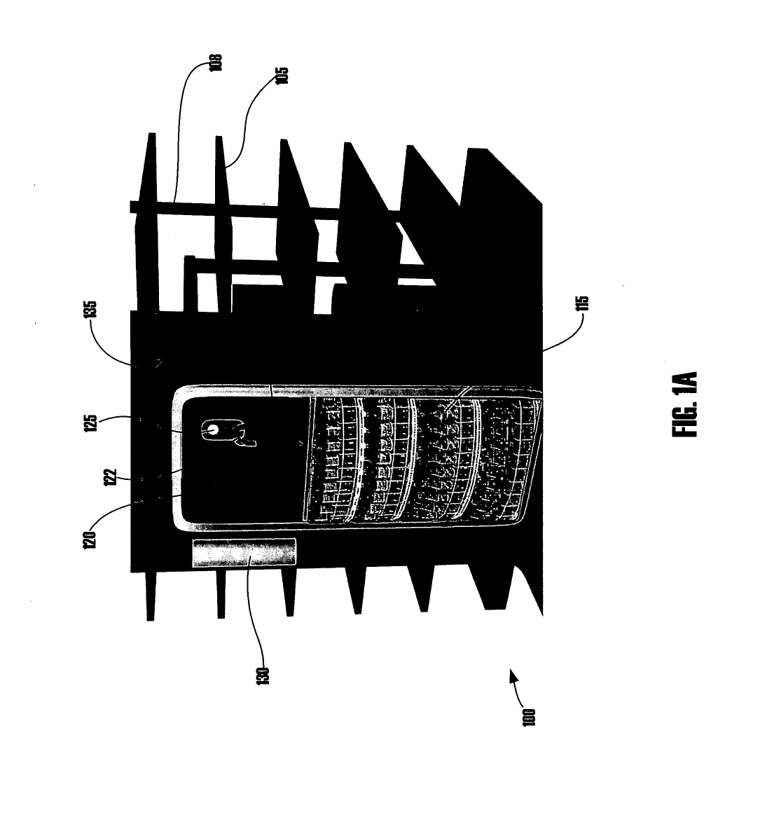

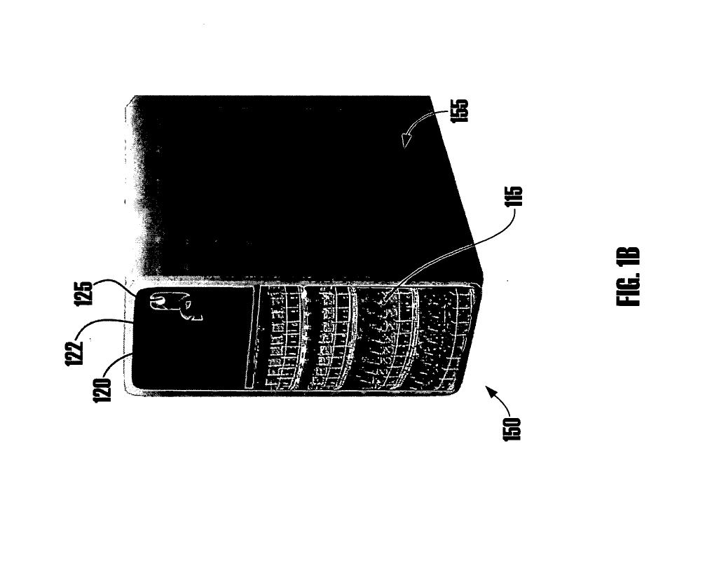

FIG. 1A shows a perspective view of a beverage marketing system 100, according to one embodiment of the present invention. The beverage marketing system 100 generally includes a shelving unit 108, a cooler 115, and a dispenser 120. As shown in FIG. 1A, the beverage marketing system 100 provides consumers access to products, such as beverages, placed on one or more shelves 105 of the shelving unit 108, and to cooled beverages located within the cooler 115. The beverage marketing system 100 also provides consumers dispensed beverage via the dispenser 120. The dispenser 120 allows consumers to sample one or more of the beverage products placed on the one or more shelves 105 or within the cooler 115. As such, using the beverage marketing system 100 of the present invention, a consumer may sample a drink product before purchasing the product.

According to one aspect of the present invention, the dispenser 120 includes a dispensing interface 125 and a spout 122. The dispensing interface 125 is operable to receive input from a consumer to cause the dispenser 120 to dispense at least one beverage. According to one aspect of the invention, the dispensing interface 125 may be one or more switches, buttons, levers, motion sensors, or a combination of such items. The dispensing interface 125 permits a consumer to instruct the dispenser 120 to dispense a particular beverage via one or more spouts, such as the spout 122 illustrated in FIG. 1. While only one dispensing interface 125 and one spout 122 are illustrated in the embodiment of FIG. 1A for purposes of brevity, it will be appreciated that multiple dispensing interfaces controlling multiple corresponding spouts may be incorporated into the beverage marketing system 100 of the present invention.

The one or more dispensing interfaces and spouts operate similar to well known conventional dispensing systems, such as those typically found at self-service fountain stations found in many restaurants. However, the dispenser 120 of the present invention may also include a flow regulator operable to control the volume of beverage dispensed by the beverage dispenser. According to one aspect of the invention, the flow regulator only permits a predetermined volume of fluid to be dispensed each time a consumer instructs the dispensing interface 125 to dispense a beverage via the spout. This may prevent an excessive amount of beverage from being dispensed from the dispenser 120 at one time. Because the beverage marketing system 100 may be placed in a publicly accessible location, the flow regulator is useful in preventing unlimited use of the dispenser 120.

According to another aspect of the present invention, the flow regulator may also include a timer, such that beverage may only be dispensed via the dispensing interface 125 and spout 122 after the passing of a predetermined period of time. After each use of the dispenser 120 the timer may be reset to count down to zero (or up to a predetermined time limit), such that the timer may instruct the flow regulator to operate only after the timer reaches zero (or the predetermined time limit). For instance, the flow regulator may require that 30 seconds pass between each use of the dispenser 120. This serves to limit rapid consecutive use of the dispenser 120.

As shown in FIG. 1, the beverage marketing system 100 of the present invention may also include a cup dispenser 130. The flow regulator may be set to dispense a predetermined volume of beverage sufficient only to partially fill cups dispensed by the cup dispenser 130, such as half-way or three-quarters full, so as to avoid inadvertent spillage by the consumer. Because the cups are filled by consumers directly below the dispenser 120, a spill or collection tray 131 may be positioned directly under the dispenser 120. The collection tray 131 may be connected to a drain, such that liquid overflowing from or missing a cup may collect in the collection tray 131 and pass through the drain by gravity to an overflow collection container behind and/or under the dispenser 120. According to another aspect of the present invention, the collection tray 131 may retain only a limited amount of fluid, after which it must be emptied. According to yet another aspect of the present invention, a small amount of air may be constantly or occasionally delivered towards the collection tray 131 via a fan to encourage evaporation of any liquid contained in the collection tray 131.

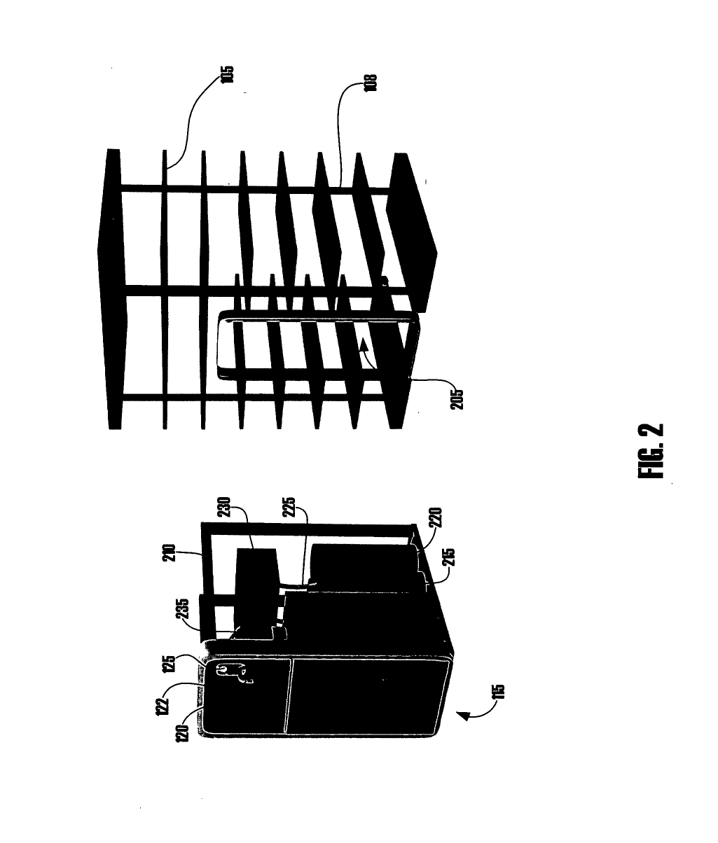

The beverage marketing system 100 illustrated in FIG. 1A is configured for use on the end of an aisle in a consumer packaged goods store, such as a grocery store, convenience store, or the like. As such, as illustrated in the embodiment shown in FIG. 1A, two opposite sides having one or more shelves 105 are exposed to a consumer, as is the third side, which includes the cooler 115 and dispenser 120 and is located in between the two opposite and exposed sides containing the one or more shelves 105. To achieve this arrangement the cooler 115 and dispenser 120 of the beverage marketing system 100 are removably inserted into an opening in the shelving unit 108. The opening in the shelving unit may be concealed by a cover 135 such that the shelving unit 108, cooler 115, and dispenser 120 appear as a single unit. The cover 135 may include advertisements or other information to attract attention to the beverage marketing system 100. As described in greater detail below with respect to FIG. 2, the body of the cooler 115, the components of the dispenser 120, and the product dispensed via the dispenser 120 are contained within a cavity defined by the shelving unit 108.

In the embodiment illustrated in FIG. 1A, the side of the beverage marketing system 100 which is opposite the cooler 115 and dispenser 120 may abut components, such as shelves or coolers, or the face of the end of an aisle. Nevertheless, the beverage marketing system of the present invention may alternatively be located in the center of an aisle or may be a freestanding unit. For instance, a beverage marketing system of the present invention may occupy the center of an aisle, such that the cooler 115 and dispenser 120 are positioned in between shelves that face the same direction as the cooler 115 and dispenser 120. As another example, the beverage marketing system may have shelves on three sides, with the cooler 115 and dispenser 120 making up the fourth side. According to yet another example, the beverage marketing system may be a freestanding unit that does not include a shelving unit or shelves, such as the beverage marketing system 150 illustrated in FIG. 1B.

As shown in FIG. 1B, the beverage marketing system 150 may be a freestanding unit that may be placed in virtually any environment. The beverage marketing system 150 shown in FIG. 1B operates like the beverage marketing system 100 described with respect to FIG. 1A, but for the absence of the shelving unit 108 and shelves 105. Because the beverage marketing system 150 is freestanding, the cooler 115 and dispenser 120 are housed within a case 155 that protects the beverage marketing system 150 in environments in which it may be placed. The case 155 may be made of aluminum, steel, stainless steel, hard plastic or other materials that protect the beverage marketing system 150 from an environment in which it is located. According to one aspect of the present invention, the beverage marketing system 150 shown in FIG. 1B may include a bill and/or coin acceptor (not illustrated) that enables the cooler to function like a vending machine. For instance, the beverage marketing system may include a dispenser integrated with a vending machine. In such a scenario, the dispenser 120 may be operable to provide samples of products purchasable from the vending machine.

According to one aspect of the invention, the beverage marketing system 150 may include all of the features described in co-pending application Ser. No. 10/755,492, titled “Interactive Networked Product Container”, filed Jan. 12, 2004, the contents of which are hereby incorporated herein by reference. For instance, according to one aspect of the present invention, the beverage marketing system 150 may also include a card reader that is operable to read information off of a consumer card. The consumer card may be a credit card, smart card, radio frequency tag, frequent shopper card, pre-paid card, receipt, and/or barcode. According to one aspect of the invention, a consumer may be required to insert his or her consumer card into the card reader to permit the marketing system to read information off of the card prior to the flow regulator permitting the dispenser 120 to dispense a sample of beverage. This may encourage consumers to apply for cards, such as cards distributed by grocery stores. This may also allow the beverage marketing system 100 to collect information stored on the cards, including consumer-related information. For instance, a consumer's card may store information about the consumer, the consumer's purchase history (including favored products) and the consumer's frequency of purchasing or sampling products. This information may be stored by the beverage marketing system 150 and uploaded either automatically or physically to a central server. It may also be used to customize marketing material provided to the consumer, as described below. The beverage marketing system 100 may also be operable to update information on a consumer's card, including providing electronic coupons on the card to encourage use of the beverage marketing system.

The beverage marketing system may also include a display device operative to display marketing information to prospective customers. The marketing information may include marketing information corresponding to the at least one individually-packaged beverage product. The marketing information may also include information on rewards or coupons offered by the beverage marketing system, such as coupons that may be downloaded onto a consumer card upon sampling a beverage using the dispenser 120. The beverage marketing system may also include a printer for printing coupons and providing offers to consumers that may be redeemed on an Internet site or local to the beverage marketing system, such as at a store in which the system resides. According to another aspect of the invention, marketing information displayed by the display device may change based on the presence of a consumer or based upon the selection of a particular product for sampling using the dispenser 120.

FIG. 2 shows a component view of the beverage marketing system illustrated in FIG. 1A, according to one aspect of the present invention. Specifically, FIG. 2 shows the cooler 115 and dispenser 120 separate from the shelving unit 108. As illustrated, the cooler 115 and dispenser 120 are contained within a cooler/dispenser frame 210 that may be removably inserted within a cavity or opening 205 in the shelving unit 108. The frame 210 may include wheels (not illustrated) to facilitate the movement of the cooler 115 and dispenser 120 into and out of the shelving unit 108. The cooler 115 and dispenser 120 are mounted within the moveable frame to permit easy access to the cooler 115 and dispenser 120. This is beneficial when the product(s) dispensed by the dispenser 120 must be refilled or recharged or when the cooler 115 and/or dispenser 120 are serviced by a technician.

As shown in FIG. 2, at least one product container 215 and at least one CO₂ supply reside within the cooler/dispenser frame 210. The at least one product container 215 may be a pre-mixed beverage or a post-mixed beverage, as are known to those of ordinary skill in the art. Where a pre-mixed system is used the pre-mixed beverage is driven from the product container(s) 215 through the product supply line 225, chiller 230, and dispenser supply line 235 and out through the spout 122, as is known in the art. The chiller cools the pre-mixed beverage prior to its dispensing by the spout 122. Where a post-mix beverage system is used, the product container(s) 215 include syrup that mixes with water or carbonated water (i.e., soda water) to make a dispensable beverage. Water is mixed with syrup for non-carbonated beverages such as lemonade, and soda water is mixed with syrup for carbonated beverages such as Coca-Cola® brand beverage sold by the Coca-Cola company of Atlanta, Ga. As such, in this embodiment water is required by the beverage marketing system 100, which may be provided from a water supply line (not illustrated) or from a canister within the cooler/dispenser frame 210.

In the post-mix embodiment, the cooler/dispenser frame 210 also includes a carbonator (not illustrated) which mixes CO₂ and water to form soda water. The carbonator, as is known in the art, may also include a pump for pressurizing water to facilitate its mixture with the CO₂. The carbonator and pump may be internal or external to the chiller 230 in the embodiment illustrated in FIG. 2. One or more syrup pumps (not illustrated) feed the syrup via one or more product supply lines 225 for mixing with the soda water. The water or soda water and syrup may be combined by the spout 122, which may be a fountain head as is known to those of skill in the art. Other alternatives known to those of ordinary skill in the art for mixing the syrup and water or soda water may also be used. Furthermore, it will be appreciated that there may be more than one dispenser supply line 235, including at least one syrup line and at least one water or soda water line. As noted above, because the dispenser 120 may be capable of dispensing multiple beverages, multiple dispenser supply lines may be used. Additional supply lines and pumps, as are well known in the art, may also be incorporated within the cooler/dispenser frame 210 for moving water, soda water, CO₂, and syrup.

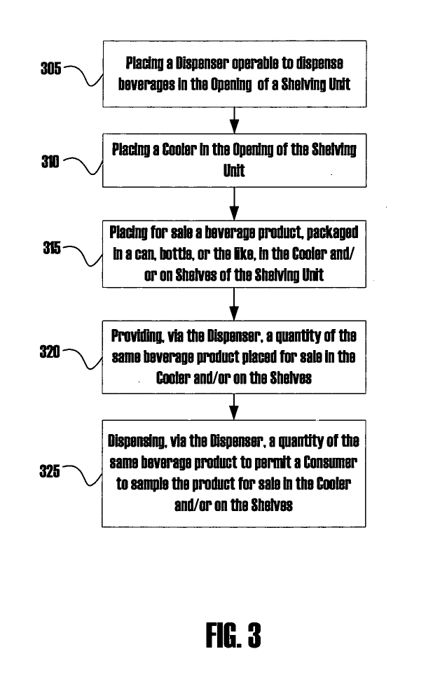

FIG. 3 is a block diagram flow chart illustrating a marketing method using a beverage marketing system, according to one embodiment of the present invention. As shown in block 305, a dispenser operable to dispense beverages is placed in the opening of a shelving unit. A cooler is also placed in the same opening of the shelving unit (block 310). In alternative embodiments the marketing method may be used without a cooler, or with a cooler located in a different opening than the opening in which the dispenser is located. Next, in block 315 beverages packaged in cans, bottles, or the like, are placed for sale in the cooler and on shelves of the shelving unit. As described above with respect to FIGS. 1A, 1B and 2, the dispenser is supplied with beverages to enable the dispenser to dispense one or more samples of the products located in the cooler or on the shelves (block 320). Thereafter, the dispenser is operable to dispense a quantity of the beverage product to permit a consumer to sample the product offered for sale in the cooler and/or on the shelves.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A beverage dispensing apparatus, comprising:
a shelving unit, said shelving unit comprising an opening and at least one shelf;
a beverage dispenser, said beverage dispenser operable to dispense at least one beverage, wherein the beverage dispenser is inserted into the opening in the shelving unit.

2. The beverage dispensing apparatus of claim 1, wherein the shelving unit comprises an end-of-aisle shelving unit having at least three sides approachable by a consumer.

3. The beverage dispensing apparatus of claim 2, wherein the opening is disposed in one of said at least three sides.

4. The beverage dispensing apparatus of claim 1, further comprising at least one cover removably affixed to said shelving unit.

5. The beverage dispensing apparatus of claim 1, further comprising at least one dispensing interface, wherein the at least one dispensing interface is operable to receive input from a consumer to cause the beverage dispenser to dispense the at least one beverage.

6. The beverage dispensing apparatus of claim 5, wherein the at least one dispensing interface is selected from the group of interfaces consisting of a switch, a button, a lever, and a motion sensor.

7. The beverage dispensing apparatus of claim 5, wherein the beverage dispenser comprises a flow regulator operable to control the volume of the at least one beverage dispensed by said beverage dispenser.

8. The beverage dispensing apparatus of claim 5, further comprising a cup dispenser operable to hold cups.

9. The beverage dispensing apparatus of claim 1, wherein the beverage dispenser is removably inserted into the opening in the shelving unit.

10. A marketing system, comprising:
a shelving unit, said shelving unit comprising an opening and at least one shelf;
a cooler, said cooler operable to retain at least one individually-packaged beverage product; and
a beverage dispenser, said beverage dispenser operable to dispense a sample of the at least one individually-packaged beverage product, wherein the sample is not provided from the at least one individually-packaged beverage product retained in the cooler.

11. The marketing system of claim 10, wherein the at least one individually-packaged beverage product comprises a soft drink.

12. The marketing system of claim 10, wherein the beverage dispenser is removably inserted into the opening in the shelving unit.

13. The marketing system of claim 12, wherein the shelving unit comprises an end-of-aisle shelving unit having at least three sides approachable by a consumer.

14. The marketing system of claim 13, wherein the opening is disposed in one of said at least three sides.

15. The marketing system of claim 10, further comprising at least one cover removably affixed to said shelving unit.

16. The marketing system of claim 10, further comprising at least one dispensing interface, wherein the at least one dispensing interface is operable to receive input from a consumer to cause the beverage dispenser to dispense the at least one beverage.

17. The marketing system of claim 16, wherein the at least one dispensing interface is selected from the group of interfaces consisting of a switch, a button, a lever, and a motion sensor.

18. The marketing system of claim 16, wherein the beverage dispenser comprises a flow regulator operable to control the volume of the at least one beverage dispensed by said beverage dispenser.

19. The marketing system of claim 10, further comprising an card reader, operable to read information off of a consumer card.

20. The marketing system of claim 19, wherein the consumer card is selected from the group consisting of a credit card, a smart card, a radio frequency tag, a frequent shopper card, a pre-paid card, and a barcode.

21. The marketing system of claim 10, further comprising at least one display device, wherein the at least one display device is operable to display marketing information to prospective customers.

22. The marketing system of claim 21, wherein the marketing information comprises marketing information corresponding to the at least one individually-packaged beverage product.

23. The marketing system of claim 10, further comprising a cup dispenser operable to hold cups.

24. A marketing system, comprising:
a product holder, the product holder operable to retain at least one individually-packaged beverage product; and
a beverage dispenser, said beverage dispenser operable to dispense a sample of the at least one individually-packaged beverage product, wherein the sample is not provided from the at least one individually-packaged beverage product,
wherein the product holder is local to and associated with the beverage dispenser.

25. The marketing system of claim 24, wherein the at least one individually-packaged beverage product comprises a soft drink.

26. The marketing system of claim 24, further comprising at least one dispensing interface, wherein the at least one dispensing interface is operable to receive input from a consumer to cause the beverage dispenser to dispense the sample of the at least one individually-packaged beverage product.

27. The marketing system of claim 26, wherein the at least one dispensing interface is selected from the group of interfaces consisting of a switch, a button, a lever, and a motion sensor.

28. The marketing system of claim 26, wherein the beverage dispenser comprises a flow regulator operable to control the volume of the at least one beverage dispensed by said beverage dispenser.

29. The marketing system of claim 24, further comprising an card reader, operable to read information off of a consumer card.

30. The marketing system of claim 29, wherein the consumer card is selected from the group consisting of a credit card, a smart card, a radio frequency tag, a frequent shopper card, a pre-paid card, and a barcode.

31. The marketing system of claim 24, further comprising at least one display device, wherein the at least one display device is operable to display marketing information to prospective customers.

32. The marketing system of claim 31, wherein the marketing information comprises marketing information corresponding to the at least one individually-packaged beverage product.

33. The marketing system of claim 24, further comprising a cup dispenser operable to hold cups.

34. The marketing system of claim 24, wherein the product holder comprises a cooler, and wherein the cooler and beverage dispenser are integrated to form the beverage marketing system.

35. A marketing method, comprising:
placing a product to be marketed on a shelving unit comprising an opening and at least one shelf;
placing, in a cooler, at least one individually-packaged beverage product, wherein the cooler is inserted into the opening; and
offering a sample of the at least one individually-packaged beverage product via a beverage dispenser local to the shelving unit and the cooler, wherein the sample is not provided from the at least one individually-packaged beverage product in the cooler.

36. The marketing method of claim 35, wherein the step of offering a sample of the at least one individually-packaged beverage product comprises offering a sample of the at least one individually-packaged beverage product via at least one dispensing interface, wherein the at least one dispensing interface is operable to receive input from a consumer to cause the beverage dispenser to dispense the at least one beverage.

37. The marketing method of claim 36, wherein the at least one dispensing interface is selected from the group of interfaces consisting of a switch, a button, a lever, and a motion sensor.

38. The marketing method of claim 35, wherein offering a sample of the at least one individually-packaged beverage product comprises offering a controlled volume of the sample, said controlled volume determined by a flow regulator.

39. The marketing method of claim 35, further comprising the step of receiving an input from a consumer prior to offering a sample of the at least one individually-packaged beverage product.

40. The marketing method of claim 35, further comprising displaying, on at least one display device, marketing information to prospective consumers.

41. The marketing method of claim 40, wherein the marketing information comprises marketing information corresponding to the at least one individually-packaged beverage product.
